(19) United States
(12) Patent Application Publication
(10) Pub. No.: US 2017/0051481 A1
(43) Pub. Date: Feb. 23, 2017

(54) Time-of-Flight Recognition System for a Bathroom Fixture

(71) Applicant: Zurn Industries, LLC, Milwaukee, WI (US)

(72) Inventor: Keith Mercer, Raleigh, NC (US)

(21) Appl. No.: 15/237,895

(22) Filed: Aug. 16, 2016

Related U.S. Application Data
(60) Provisional application No. 62/206,036, filed on Aug. 17, 2015.

(51) Int. Cl. E03C 1/05; G05D 7/06; G01S 7/486; G01S 17/10; G01S 17/88

(52) U.S. Cl. CPC E03C 1/057; G01S 17/10; G01S 17/88; G01S 7/4865; G05D 7/0635

(57) ABSTRACT

A recognition system for a bathroom fixture operates by sending a photon pulse from an emitter, monitoring for a presence of an object within a predefined detection zone, and operating the bathroom fixture if the distance of the object is within the predefined detection zone. The monitoring occurs by detecting photons with a sensor, establishing a correlated or uncorrelated state of the detected photons, optically filtering the detected photons, calculating a distance of the object from the sensor based on the photon pulse sent from the emitter and the returned photons collected at the sensor, and determining whether the distance of the object from the sensor falls within the predefined detection zone.

### CROSS-REFERENCE TO RELATED APPLICATIONS

This application claims the benefit of U.S. Provisional Patent Application No. 62/206,036 filed Aug. 17, 2015, the contents of which are incorporated by reference herein in their entirety for all purposes.

### TECHNICAL FIELD

This disclosure relates to recognition systems for bathroom fixtures. In particular, this disclosure relates to recognition systems for the accurate detection of an object within a pre-determined distance from a sensor for the purpose of selectively operating the fixture.

### BACKGROUND

Infrared sensors have been used for detection or recognition systems in automated bathroom fixtures such as sink faucets, soap dispensers, and towel dispensers. Infrared sensors are active sensors that utilize low power detection and rely on the reflective properties of intended targets to accurately detect the presence of an object (for example, a user's hand).

Typical infrared sensors suffer from at least three primary drawbacks. First, the detection zone is defined by the entire line-of-sight of the sensor leading to a loosely defined detection zone. For example, a typical infrared sensor used in a sink installation may detect a dirty sink surface as a false positive resulting in undesirable functionality. This line-of-sight detection zone can lead to missed users and false detections. Second, detection is highly dependent on the reflective properties of a target object. The infrared sensor will react differently to varying colors and textures leading to inconsistent or undesirable operation. Finally, ambient light can heavily affect the performance of typical infrared sensors. In order to overcome inconsistencies introduced by lighting, systems are tuned individually to achieve desirable performance, and may require initial or periodic calibration. This leads to increased installation costs and installer dependence, leading to inconsistency of operation.

Therefore, a recognition system and corresponding method of operation compatible with bathroom fixtures is needed possessing improved functionality.

### SUMMARY OF THE INVENTION

The foregoing needs are met by the methods, apparatus, and/or systems for recognizing and responding to the presence of a target object according to the disclosure.

According to one aspect, a method of operating a recognition system for a bathroom fixture is disclosed. The method includes sending a photon pulse from an emitter, monitoring for a presence of an object within a predefined detection zone, and operating the bathroom fixture if the distance of the object from the sensor is within the predefined detection zone. The step of monitoring for the presence of an object within a predefined detection zone includes detecting photons with a sensor in which the detected photons include returned photons from the photon pulse sent from the emitter that have reflected off of the object, establishing a correlated state or an uncorrelated state of the detected photons, optically filtering the detected photons, calculating a distance of the object from the sensor based on the photon pulse sent from the emitter and the returned photons collected at the sensor, and determining whether the distance of the object from the sensor falls within the predefined detection zone.

In some forms, the predefined detection zone may be selected from set amounts, distances, or percentages of traveled distance of the photons. More specifically, the predefined detection zone may be within the range of one inch from the sensor to two inches from a fixed opposite surface, such that a false photon detection from the fixed opposite surface is avoided.

Calibration of the predefined detection zone may occur before the sensor begins to monitor. The controller may further be set to periodically re-calibrate to the predefined detection zone.

The distance calculated may be a result of the time lapse between the sending the photon pulse and detecting the returned photons (i.e., the distance may be determined by multiplying the speed of the photon by the time lapse between emission and reception of the photon). Furthermore, to ensure positive detection of an object, the step of sending a photon pulse may comprise sending a plurality of photon pulses for use in establishing the correlated state or the uncorrelated state of the detected photons.

In some forms, the sensor may include an array of Single Photon Avalanche Diode (SPAD) detectors.

To improve detection and accuracy, the emitted and detected photons may be clustered around a wavelength outside of the visible light spectrum. Specifically, the visible light spectrum is defined by wavelengths between 390 nanometers to 700 nanometers. In certain situations, it may be considered advantageous to have the photons clustered around a wavelength of 850 nanometers.

As it is established whether the detected photons are in the correlated state or the uncorrelated state, the correlation (or lack thereof) may be used to establish how the method proceeds. For example, if the detected photons are in the correlated state, then optical filtering may be executed. Whereas if the detected photons are in the uncorrelated state, the emitter may continue to send photon pulses. In regards to optically filtering the photons, this may include determining if the detected photons are ambient (potentially based on information also detected from an ambient light sensor) and continuing to send photon pulses if the detected photons are indeed primarily ambient so as to avoid a false positive detection of an object in the pre-defined zone. Additionally, the step of optically filtering the detected photons may result in a lowering of the system noise.

According to one aspect, an automatically controlled water valve system is disclosed. The automatically controlled water valve system includes a water valve, an actuator, a time-of-flight sensor, and a controller. The water valve is moveable between an open position and a closed position. When the valve is in the open position water flow is provided, and in the closed position water flow is inhibited. The actuator is coupled to the water valve to move the water valve between the open position and the closed position. The time-of-flight sensor is arranged to send and receive photon pulses. The controller is in communication with the actuator and the time-of-flight sensor and defines a detection zone for the time-of-flight sensor. The controller is configured to establish a correlated state or an uncorrelated state of the photons that are received by the time-of-flight sensor, is configured to optically filter the photon pulses that are received by the time-of-flight sensor, and activates the actuator in response to signals from the time-of-flight sensor indicating that a target object is within the detection zone.

When the water valve is in the open position, the controller may monitor the defined detection zone. In such a case, the controller may be configured to deactivate the actuator in response to the signals from the time-of-flight sensor (for example, if a hand of a user is removed from the predefined detection zone).

The time-of-flight sensor may specifically utilize an array of Single Photon Avalanche Diode detectors.

In some forms, the time-of-flight sensor may be positioned outside a bathroom fixture or within a bathroom fixture. For example, the time-of flight sensor may be placed at the head of a faucet, just above and outward the position of the aerator. In other examples, the time-of-flight sensor may be placed on a radially outward facing surface of a faucet such as along the “goose-neck” of the faucet body. Still yet the sensor could be mounted in or on a surface that is not the fixture itself such as, for example, on a portion of the sink.

According to another aspect, a recognition system for a bathroom fixture is disclosed. The recognition system includes a time-of-flight sensor and a controller. The time-of-flight sensor is configured to send and receive photon pulses and to send a distance signal. The controller receives the distance signal and triggers an operation if the distance signal falls within a detection zone.

In some forms, the controller may utilize an ambient light sensor to detect and account for the ambient light conditions in view of the time-of-flight sensor. The ambient light sensor may result in a reduction in system noise.

Prior to the recognition system beginning to monitor, the system may be calibrated to the desired detection zone.

This method, automatically controlled water valve system, and recognition system may be used in a number of bathroom fixtures including, but not limited to, faucets, soap and other fluid dispensers, toilets, doors, and paper towel dispensers.

These and other aspects of the invention will become apparent from the following description. In the description, reference is made to the accompanying drawings which form a part hereof, and in which there is shown embodiments of the invention. Such embodiments do not necessarily represent the full scope of the invention and reference is made therefore, to the claims herein for interpreting the scope of the invention.

### BRIEF DESCRIPTION OF THE DRAWINGS

The present disclosure will hereafter be described with reference to the accompanying drawings, wherein like reference numerals denote like elements.

FIG. 1 is a schematic representation of one exemplary embodiment of a recognition system.

FIG. 2 is a front view of a time-of-flight sensor of the recognition system shown in FIG. 1.

FIG. 3 is a right side view of the time-of-flight sensor of FIG. 2.

FIG. 4 is a rear view of the time-of-flight sensor of FIG. 2.

FIG. 5 is a diagram illustrating a principal of operation of the time-of-flight sensor of FIG. 2.

FIG. 6 is a diagram illustrating how photon pulses of the time-of-flight sensor of FIG. 2 are correlated.

FIG. 7 is a chart showing the wavelengths of various detected photons in which the detected wavelengths are clustered around 850 nanometers.

FIG. 8 is a chart showing convergence time for the recognition system versus actual or target ranges for objects of varying reflectance.

FIG. 9 is a flow chart representing a method of operating the recognition system shown in FIG. 1.

### DETAILED DESCRIPTION OF PREFERRED EMBODIMENTS

Before the present invention is described in further detail, it is to be understood that the invention is not limited to the particular aspects described. It is also to be understood that the terminology used herein is for the purpose of describing particular aspects only, and is not intended to be limiting. The scope of the present invention will be limited only by the claims. As used herein, the singular forms “a”, “an”, and “the” include plural aspects unless the context clearly dictates otherwise.

It should be apparent to those skilled in the art that many additional modifications beside those already described are possible without departing from the inventive concepts. In interpreting this disclosure, all terms should be interpreted in the broadest possible manner consistent with the context. Variations of the term “comprising”, “including”, or “having” should be interpreted as referring to elements, components, or steps in a non-exclusive manner, so the referenced elements, components, or steps may be combined with other elements, components, or steps that are not expressly referenced. Aspects referenced as “comprising”, “including”, or “having” certain elements are also contemplated as “consisting essentially of” and “consisting of” those elements, unless the context clearly dictates otherwise. It should be appreciated that aspects of the disclosure that are described with respect to a system are applicable to the methods, and vice versa, unless the context explicitly dictates otherwise.

Numeric ranges disclosed herein are inclusive of their endpoints. For example, a numeric range of between 1 and 10 includes the values 1 and 10. When a series of numeric ranges are disclosed for a given value, the present disclosure expressly contemplates ranges including all combinations of the upper and lower bounds of those ranges. For example, a numeric range of between 1 and 10 or between 2 and 9 is intended to include the numeric ranges of between 1 and 9 and between 2 and 10.

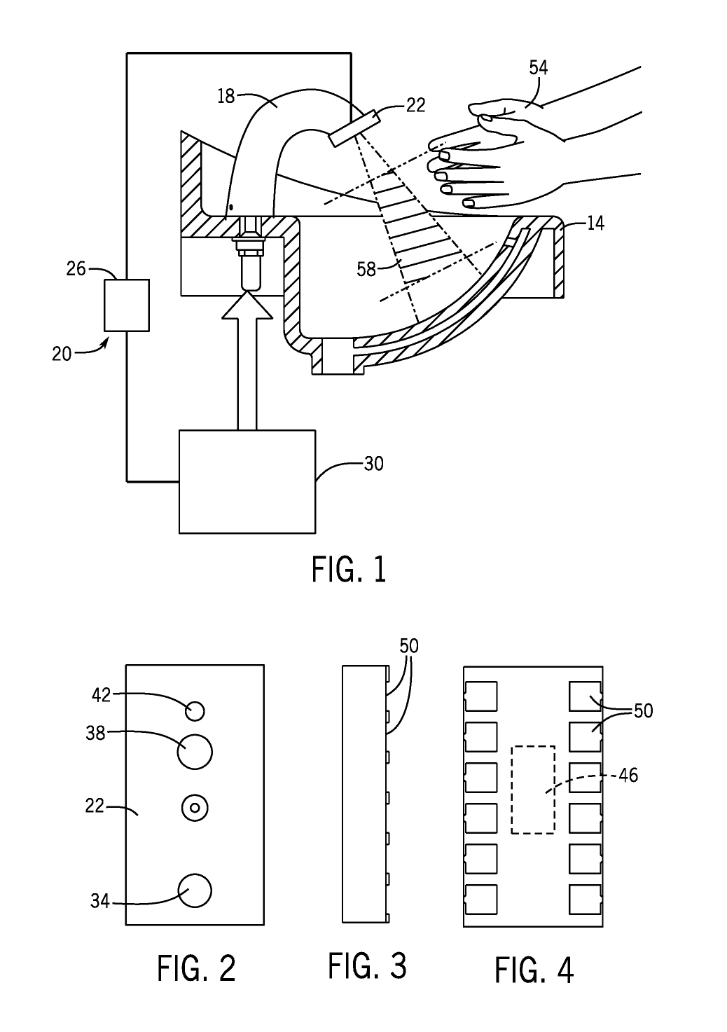

FIG. 1 shows an exemplary bathroom fixture in the form of a sink 14 that includes an automated faucet 18 installed therein. In other embodiments, the bathroom fixture may be a toilet, urinal, soap dispenser, towel dispenser, door, toilet paper dispenser, or another fixture/appliance, as desired. Those skilled in the art will recognize that aspects of the below disclosure and the claims can apply to fixtures other than sinks and may indeed include fixtures outside a bathroom.

The automated faucet 18 includes a recognition system 20 that includes a time-of-flight sensor 22 in communication with a controller 26 (schematically indicated in FIG. 1) that provides commands to an actuator in the form of a water valve 30. The time-of-flight sensor 22 is shown in detail in FIGS. 2-4 and includes a light emitter 34, an ambient light sensor 38, and a sensor 42. As will be described in more detail below, the light emitter 34 emits photons that the sensor 42 detects photons (returned photons from the light emitter and/or ambient photons). The ambient light sensor 38 is able to automatically detect and account for the ambient lighting in view of the time-of-flight sensor 22.

The time-of-flight sensor 22 includes an onboard sensor controller 46 that processes the raw signals from the light emitter 34, the ambient light sensor 38, and the sensor 42 and communicates with the controller 26 via the twelve connections 50 located on the rear of the time-of-flight sensor 22. In one exemplary embodiment, the time-of-flight sensor 22 is a model VL6180X 3-in-1 proximity sensor offered by STMicroelectronics of Geneva, Switzerland.

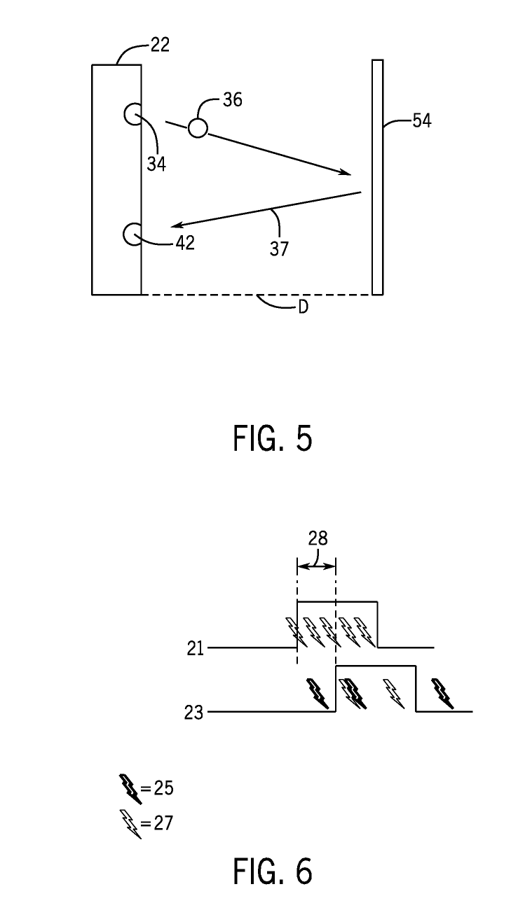

FIGS. 5 and 6 show how pulses of photons 36 are emitted from the light emitter 34, reflect off an object 54 (for example, the hands of a user), return along a path 37 and are detected by the sensor 42. As shown in FIG. 6, the sensor controller 46 is able to correlate emitted photons from detected ambient photons. The emitted photon pulse 21 is shown is the top line with the detected photon pulse 23 being illustrated on the lower line. The emitted photon pulse 21 is comprised of photons 27 that are later detected by the sensor 42 with intervening delay 28. The detected photon pulse 23 is potentially comprised of both the returned, correlated photons 27 and ambient, uncorrelated photons 25. The sensor controller 46 records the time lapse or delay 28 between sending the photon pulse along and detecting the photons. A calculation is completed to determine a distance between the time-of-flight sensor 22 and the target object 54. Effectively, the measured distance is equal to the photon travel time multiplied by the speed of light. Because the speed of light is extremely fast in comparison to the speed of the detection methods, in calculating distance, it may be the case that many repeated, timed pulses are used to establish correlation and some offset is factored in based on the limitations of into the time-of-flight sensor 22.

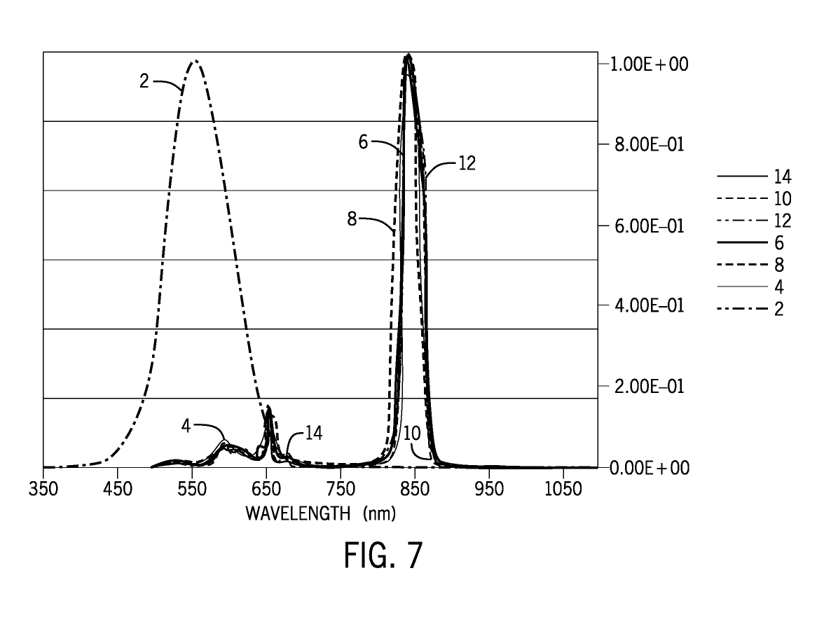

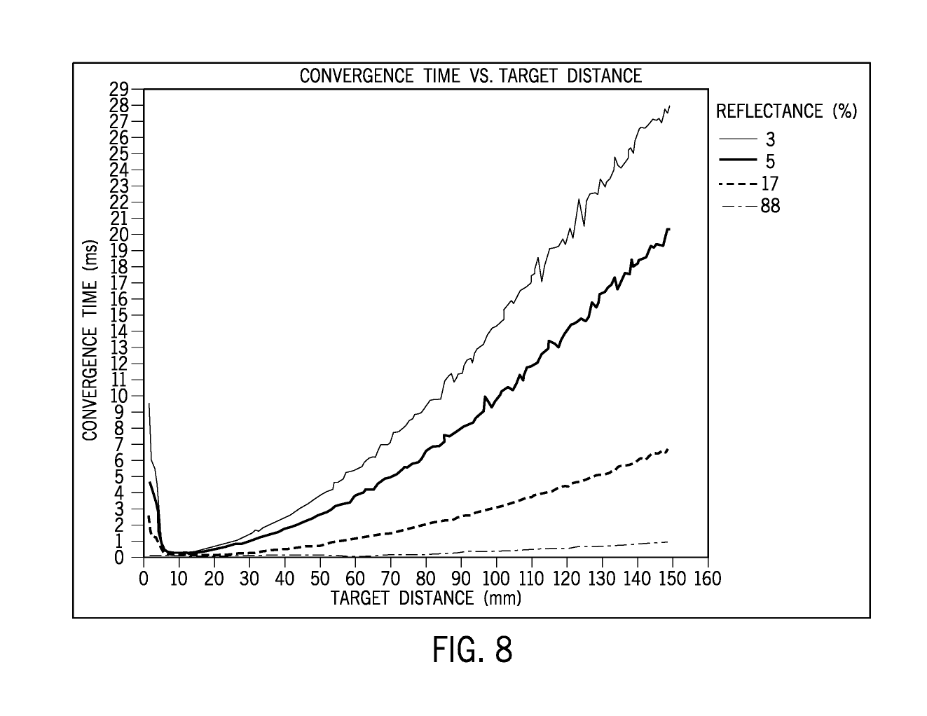

FIGS. 7-8 illustrate how the time-of-flight sensor 22 responds well to target objects 54 of varying reflectance and provides a very fast response. The ambient light sensor 38 and the sensor controller 46 allow for optical filtering as shown in FIG. 7. In FIG. 7, the detected photons are correlated and clustered around the 850 nanometer wavelength, a value outside the visible light spectrum. This reduces the impact of ambient, uncorrelated photons and lowers system noise. One notable effect of this optical filtering is that the recognition system 20 does not report false distance and therefore false positives in high ambient light conditions. Photopic light 2 is shown with photon pulses clustered around 850 nanometers. Photon pulse 14 shows a 0 degree shift, photon pulse 10 shows a 5 degree shift, photon pulse 12 shows a 10 degree shift, photon pulse 6 shows a 15 degree shift, photon pulse 8 shows a 30 degree shift, and photon pulse 4 shows a 50 degree shift. FIG. 8 shows that convergence time, while different for various reflectivities of the object being detected, is not highly dependent on how reflective a target object is (i.e., the convergence time is relatively small—under 30 ms for distances of up to 160 mm). Thus, the range of conversion times can be used to turn the sensor off if an object is not detected within a certain amount of time (i.e., correlation does not occur). Turning the sensor off after this period of time can save power.

Note that by observation it has been found that the reflectance of the target object does not result in a significantly different calculated target distance and a generally linear dependence between the two independent of the reflectance of the object.

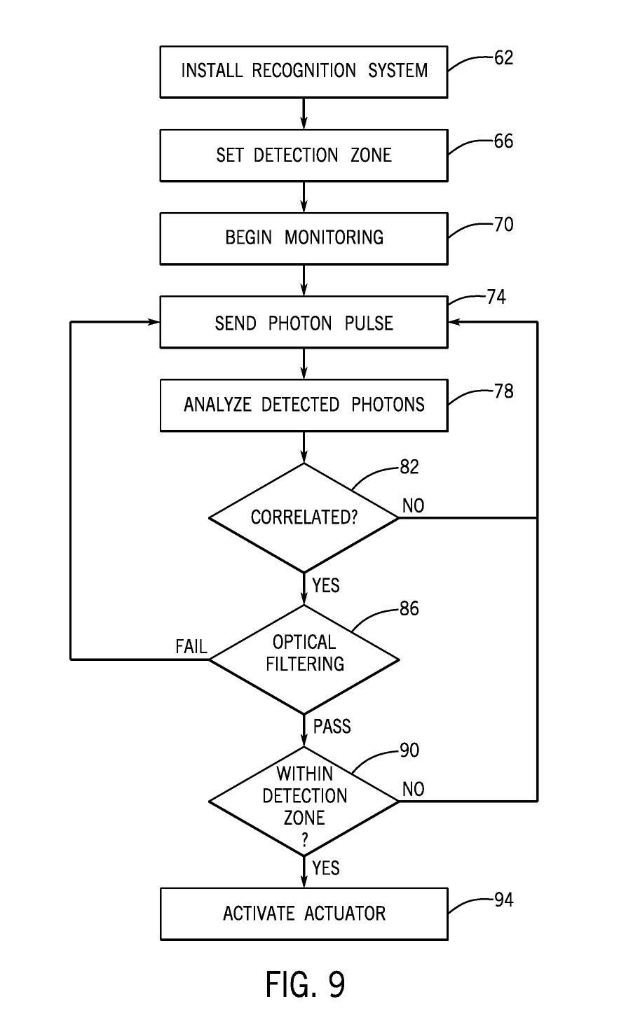

Setup and operation of the exemplary recognition system 20 will be described below with reference to FIG. 9. When the recognition system 20 is installed onto the sink 14, a detection zone 58 is defined within the controller 26. FIG. 1 shows a representation of the detection zone 58 wherein the sink 14 does not enter into the detections zone 58 such that a false positive from the sink 14 surface is not possible.

With reference to FIG. 9, the sink 14 and the recognition system 20 are installed at step 62. After installation, the detection zone 58 is set in the controller 26 at step 66. The controller 26 may be programmed to set the detection zone to be a certain distance from the sensor 22 and opposite surface (i.e., bowl surface of the sink). For example, after initial installation, the limits of sensing range may be automatically calibrated to be one inch from the sensor and two inches from opposite end of the sink (or other pre-determined or set amounts, distances, or percentages of traveled distance of the photons). The controller 26 may also be set to periodically re-calibrate to ensure maintained accuracy of the system. Alternatively, the detection zone 58 may be preset based on the product (e.g., sink 14 or faucet 18 it is packaged with) and not dependent on the particular installation conditions. With the installation and setup complete, the recognition system 20 is initialized and starts to monitor the detections zone 58 at step 70. During monitoring, photon pulses are sent from the light emitter 34 at step 74. Detected photons are received by the position return sensor 42 and analyzed at step 78. If the detected photons are correlated at step 82, then the optical filtering is executed at step 86. If the detected photons are not correlated at step 82, then the recognition system 20 takes no action and continues sending photon pulses at step 74. If the optical filtering at step 86 determines that the detected photons were ambient, then the recognition system 20 takes no action and continues sending photon pulses at step 74. If the optical filtering determines that the returned photons were emitted from the light emitter 34, then the controller 26 analyzes the distance data returned by the time-of-flight sensor 22 at step 90 to determine if the target object 54 is within the defined detection zone 58. If the target object 54 is within the detection zone 58 at step 90, the controller 26 communicates to actuate the water valve 30 at step 94 and water flows through the faucet 18 into the sink 14. If the target object 54 is outside the detection zone 58, no action is taken and the recognition system 20 continues sending photon pulses at step 74.

Similarly, when water is flowing, the recognition system 20 can continue to monitor the detection zone 58 and deactivates the water valve 30 when the target object 54 leaves the detection zone 58. The detection zone is not affected by the water flowing. The sensor can be appropriately placed and calibrated depending on the fixture being used.

A number of alternative arrangements are possible within the scope of the above disclosure. For example, a similar recognition system could be used for toilet flush activation, ensuring that a flush only occurs when a user exits the toilet area. Alternatively, a towel dispenser could be arranged to only pay out towels when a user's hand is within a predefined area relative to the dispenser. Numerous alternatives exist and will be recognized by those skilled in the art.

The time-of-flight sensor 22 offers several advantages to more convention proximity detectors. Target object color and texture do not adversely affect performance, the recognition system 20 is substantially immune to ambient light issues, it provides a well defined detection zone 58, and adjacent surfaces (for example, the sink 14) are ignored and do not trigger false activation.

While there has been shown and described what are at present considered the preferred embodiments of the invention, it will be obvious to those skilled in the art that various changes and modifications can be made therein without departing from the scope of the invention defined by the appended claims.

What is claimed is:

1. A method of operating a recognition system for a bathroom fixture, the method comprising:
sending a photon pulse from an emitter;
monitoring for a presence of an object within a predefined detection zone by:
detecting photons with a sensor, the detected photons including returned photons from the photon pulse sent from the emitter that have reflected off of the object;
establishing a correlated state or an uncorrelated state of the detected photons;
optically filtering the detected photons;
calculating a distance of the object from the sensor based on the photon pulse sent from the emitter and the returned photons collected at the sensor; and
determining whether the distance of the object from the sensor falls within the predefined detection zone; and
operating the bathroom fixture if the distance of the object is within the predefined detection zone.

2. The method of claim 1, wherein the predefined detection zone is selected from set amounts, distances, or percentages of traveled distance of the returned photons.

3. The method of claim 2, wherein the predefined detection zone is within the range of one inch from the sensor to two inches from a fixed opposite surface, such that a false photon detection from the fixed opposite surface is avoided.

4. The method of claim 1, further comprising calibrating the predefined detection zone before the sensor begins to monitor.

5. The method of claim 1, wherein the distance calculated is a result of the time lapse between sending the photon pulse and detecting the returned photons.

6. The method of claim 1, wherein sending a photon pulse further comprises sending a plurality of photon pulses for use in establishing the correlated state or the uncorrelated state of the detected photons.

7. The method of claim 1, wherein a controller is set to periodically re-calibrate to the predefined detection zone.

8. The method of claim 1, wherein the detected photons are at a wavelength outside of the wavelength range of 390 nanometers to 700 nanometers.

9. The method of claim 8, wherein the detected photons are at a wavelength of 850 nanometers.

10. The method of claim 1, wherein the sensor includes an array of Single Photon Avalanche Diode detectors.

11. The method of claim 1, wherein the step of optically filtering the detected photons includes determining if the detected photons are ambient and continuing to send photon pulses if the detected photons are ambient.

12. The method of claim 1, wherein the step of establishing the correlated state or the uncorrelated state of the detected photons includes executing the optical filtering if the detected photons are in the correlated state and continuing to send photon pulses if the detected photons are in the uncorrelated state.

13. The method of claim 1, wherein optically filtering the detected photons includes lowering system noise.

14. An automatically controlled water valve system comprising:
a water valve moveable between an open position providing water flow and a closed position inhibiting water flow;
an actuator coupled to the water valve and moving the water valve between the open position and the closed position;
a time-of-flight sensor arranged to send and receive photon pulses; and
a controller in communication with the actuator and the time-of-flight sensor and defining a detection zone, the controller configured to establish a correlated state or an uncorrelated state of the photon pulses that are received by the time-of-flight sensor, further configured to optically filter the photon pulses that are received by the time-of-flight sensor, and activate the actuator in response to signals from the time-of-flight sensor indicating a presence of a target object within the detection zone.

15. The system of claim 14, wherein the controller is further configured to deactivate the actuator in response to the signals from the time-of-flight sensor.

16. The system of claim 14, wherein when the water valve is in the open position, the controller is configured to monitor the detection zone.

17. The system of claim 14, wherein the time-of-flight sensor utilizes an array of Single Photon Avalanche Diode detectors.

18. A recognition system for a bathroom fixture, the recognition system comprising:
a time-of-flight sensor configured to send and receive photon pulses and send a distance signal; and
a controller receiving the distance signal and triggering an operation if the distance signal falls within a detection zone.

19. The system of claim 18, further comprising an ambient light sensor that detects and accounts for the ambient lighting in view of the time-of-flight sensor.

20. The system of claim 18, wherein the controller is further configured to calibrate the detection zone before the recognition system begins to monitor.
